(19) United States
(12) Patent Application Publication
(10) Pub. No.: US 2016/0132501 A1
(43) Pub. Date: May 12, 2016

(54) DETERMINING ANSWERS TO INTERROGATIVE QUERIES USING WEB RESOURCES

(71) Applicant: Google Inc., Mountain View, CA (US)

(72) Inventors: Advay Mengle, Sunnyvale, CA (US); Stephen Walters, San Francisco, CA (US); Md Sabbir Yousuf Sanny, Sunnyvale, CA (US); Kartik Singh, New Delhi (IN); Burcu Karagol Ayan, Palo Alto, CA (US); Tania Bedrax Weiss, Sunnyvale, CA (US); Anna Patterson, Saratoga, CA (US)

(21) Appl. No.: 14/709,441

(22) Filed: May 11, 2015

Related U.S. Application Data
(60) Provisional application No. 62/076,919, filed on Nov. 7, 2014.

(51) Int. Cl. G06F 17/30

(52) U.S. Cl. CPC G06F 17/3043; G06F 17/30525; G06F 17/30864

(57) ABSTRACT

Methods and apparatus related to using web resources to determine an answer for a query. Some implementations are directed generally to determining answers to interrogative queries that are submitted by users via computing devices of the users, such as typed or spoken queries submitted via a search engine interface. Some implementations are directed to determining answers to interrogative queries that are automatically formulated to identify missing information, verify existing information, and/or update existing information in a structured entity database.

### BACKGROUND

Search engines provide information about resources such as web pages, images, text documents, and/or multimedia content. A search engine may identify the resources in response to a user's search query that includes one or more search terms. The search engine ranks the resources based on the relevance of the resources to the query and the importance of the resources and provides search results that include aspects of and/or links to the identified resources.

### SUMMARY

This specification is directed generally to using web resources to determine an answer for a query. For example, an answer for an interrogative query may be determined based on textual snippets identified from search result resources that are responsive to the interrogative query. As described in more detail below, various techniques may be utilized to determine the interrogative query, to determine the search result resources, to determine the textual snippets of the search result resources, and/or to determine one or more answers based on the textual snippets.

Some implementations are directed to determining answers to interrogative queries that are submitted by users via computing devices of the users, such as typed or spoken queries submitted via a search engine interface. For example, an interrogative query of “What is the highest point in Louisville, Ky.” may be submitted by a user via a computing device. An answer for the interrogative query may be determined based on textual snippets identified from search result resources that are responsive to the interrogative query. For instance, snippets from multiple webpages that are responsive to the interrogative query may include the location “South Park Hill” (e.g., snippets such as “The highest point is South Park Hill, elevation 902 feet . . . ” and “near South Park Hill (elevation 902), the highest point . . . ”). The location “South Park Hill” may be determined as an answer to the interrogative query based on one or more factors, such as: it being annotated as a location (e.g., a location may be identified as an answer based on presence of “where” in the interrogative query), it having a syntactic relationship in the snippets to other terms of the interrogative query (e.g., a positional and/or parse tree relationship to “highest point”), a count of the snippets that include a reference to the location, and/or other factors. The determined answer may be provided to the computing device for visual and/or audible presentation to the user in response to the interrogative query. As one example, the determined answer may be provided for prominent presentation on a search results webpage, optionally in combination with other search results for the interrogative query.

Some implementations are directed to determining answers to interrogative queries that are automatically formulated to identify missing information, verify existing information, and/or update existing information in a structured entity database, such as Knowledge Graph. For example, techniques described herein may be utilized to find a missing object in a (subject, relationship, object) triple of a structured entity database. For instance, assume the actress “Jennifer Aniston” is a known entity in an entity database, but the entity database does not define where she was born. One or more interrogative queries may be generated based on the subject (Jennifer Aniston) and the relationship (e.g., “place of birth”) of the triple, such as the query: “where was Jennifer Aniston born”. In some implementations, one or more of the interrogative queries may optionally be generated based on other known relationships for the entity. For instance, the actress “Jennifer Aniston” may have an “occupation” relationship that is associated with “actress” and a generated interrogative query may be “where was the actress Jennifer Aniston born”. Textual snippets from search result resources that are responsive to one or more of the interrogative queries may be identified and utilized to determine an answer to the interrogative query—and the answer may be utilized in populating the missing object in the triple. For instance, multiple textual snippets may indicate Jennifer Aniston was born in “Los Angeles, Calif.” and an entity associated with the city of Los Angeles in the state of California may be included as the missing object in the triple.

In some implementations, a computer implemented method may be provided that includes: identifying an entity in a structured database, the structured database defining relationships between entities; determining the entity lacks sufficient association in the structured database for a relationship, the lack of sufficient association for the relationship indicating one of: absence of any association of the entity for the relationship, and absence of a confident association of the entity for the relationship; generating at least one interrogative query based on the entity and the relationship; identifying textual snippets of search result resources that are responsive to the interrogative query; determining, based on the textual snippets, one or more candidate answers for the interrogative query; selecting at least one answer of the candidate answers; and defining an association for the relationship in the structured database, the association being between the entity and a relationship entity associated with the answer.

This method and other implementations of technology disclosed herein may each optionally include one or more of the following features.

In some implementations, the answer is associated with the relationship entity in one or more annotations associated with the textual snippets.

In some implementations, the method further comprises: determining the relationship entity is previously undefined in the structured database; generating at least one additional interrogative query based on the relationship entity and an additional relationship; determining, based on content of additional search result resources that are responsive to the additional interrogative query, at least one additional relationship entity that is distinct from the entity and distinct from the relationship entity; and defining, in the structured database, an additional association between the relationship entity and the additional relationship entity for the additional relationship. In some of those implementations, determining the at least one additional relationship entity comprises: identifying additional textual snippets of the additional search result resources; determining, based on the additional textual snippets, one or more candidate additional relationship entities that include the additional relationship entity; and selecting the additional relationship entity from the candidate additional relationship entities.

In some implementations, the method further comprises: determining the relationship entity is previously undefined in the structured database; generating at least one additional query based on the relationship entity; and determining, based on content of one or more additional search result resources that are responsive to the additional query, that the relationship entity is a valid entity, wherein defining the association between the entity and the relationship entity for the relationship occurs based on determining that the relationship entity is a valid entity. In some of those implementations, the at least one additional query is generated based on an additional relationship and determining the relationship entity is a valid entity comprises: determining, based on textual snippets of the additional search result resources that are responsive to the query, an association between the relationship entity and at least one additional relationship entity, the additional relationship entity distinct from the entity and distinct from the relationship entity.

In some implementations, the method further comprises: identifying an additional relationship of the relationship entity and an additional relationship entity associated with the relationship entity for the additional relationship; generating at least one additional query based on the relationship entity, the additional relationship, and the entity; and determining occurrence of the additional relationship entity in additional search result resources that are responsive to the additional query; wherein defining the association between the entity and the relationship entity is based on occurrence of the additional relationship entity in the additional search result resources. In some of those implementations, generating the additional query is further based on the relationship.

In some implementations, generating the interrogative query based on the entity and the relationship comprises: generating one or more first terms of the query based on an alias of the entity and generating one or more second terms of the query based on terms mapped to the relationship.

In some implementations, identifying the textual snippets of the search result resources comprises: identifying the snippets based on the snippets including at least one of: an alias of the entity, and a term associated with a grammatical characteristic that is mapped to the relationship.

In some implementations, identifying the textual snippets of the search result resources, comprises: receiving the snippets from a search system in response to submitting the interrogative query to the search system.

In some implementations, determining, based on the textual snippets, one or more candidate relationship entities that are each distinct from the entity comprises: determining the candidate relationship entities based on the candidate relationship entities each being associated with a grammatical characteristic that is mapped to the relationship.

In some implementations, selecting at least one relationship entity of the candidate relationship entities comprises: selecting the relationship entity based on a count of the identified textual snippets that include a reference to the relationship entity.

In some implementations, selecting at least one relationship entity of the candidate relationship entities comprises: selecting the relationship entity based on a count of the search result resources that include the identified textual snippets that include a reference to the relationship entity.

In some implementations, selecting at least one relationship entity of the candidate relationship entities comprises: selecting the relationship entity based on measures associated with the search result resources that include the identified textual snippets that include a reference to the relationship entity.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which an answer to an interrogative query may be determined.

FIG. 2 illustrates an example of automatically generating an interrogative query to identify missing information, verify existing information, and/or update existing information in a structured database; determining one or more answers for the interrogative query; and using the answers to modify the structured database.

FIG. 3A illustrates an example entity of a structured database and example relationships of that entity in the structured database.

FIG. 3B illustrates an example interrogative query generated based on the example entity of FIG. 3A and based on one of the example relationships of FIG. 3A that lacks association to another entity.

FIG. 3C illustrates example textual snippets that may be identified from search result resources that are responsive to the interrogative query of FIG. 3B.

FIG. 3D illustrates an example of an association between the example entity of FIG. 3A and entities selected based on the example textual snippets of FIG. 3C, for the relationship of “sisters”.

FIG. 4 is a flow chart illustrating an example method of formulating an interrogative query based on information in a structured entity database, determining one or more answers for the interrogative query, and using the answers to modify the entity database.

FIG. 5 is a flow chart illustrating an example method of determining one or more answers to an interrogative query submitted from a computing device of a user, and providing the answers for presentation to the user.

FIG. 6 illustrates an example graphical user interface for displaying an answer and other search results in response to an interrogative query.

FIG. 7 illustrates an example architecture of a computer system.

### DETAILED DESCRIPTION

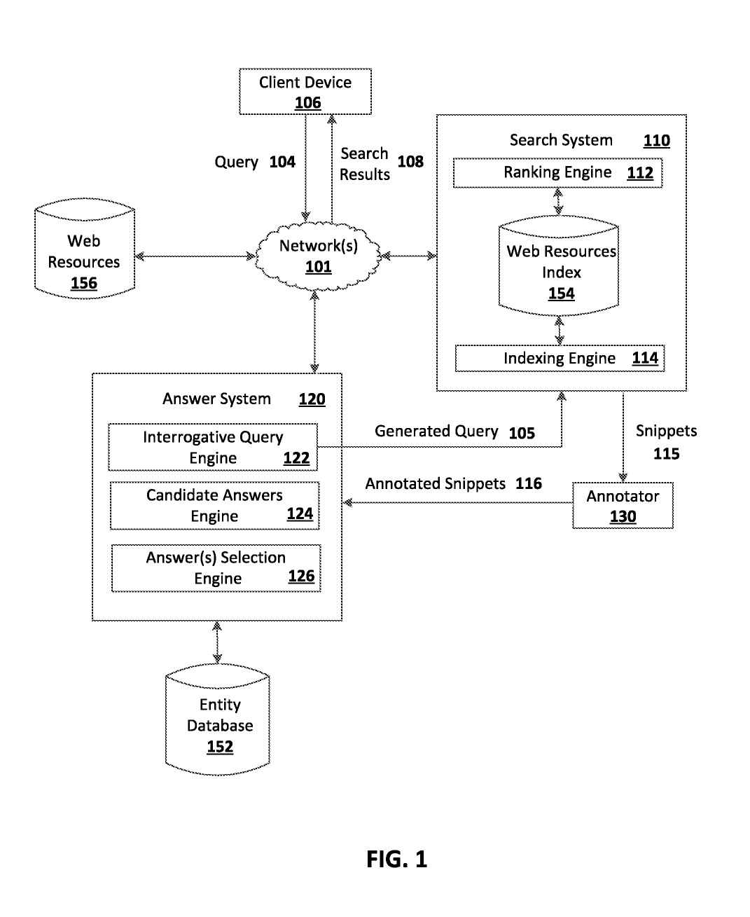

FIG. 1 illustrates an example environment in which an answer to an interrogative query may be determined. As used herein, an interrogative query is a query that includes one or more indications that indicates it is a question that seeks one or more answers. Various techniques may be utilized to optionally identify a query is an interrogative query and/or to generate an interrogative query. In some implementations, a query may be identified as an interrogative query based on one or more n-grams that may be included in the query. For example, a query may be identified as an interrogative query based on matching a prefix or other segment of the query to one or more inquiry n-grams such as “how”, “how to”, “where”, “when”, “what”, “tell me”, “highest”, “tallest”, “richest”, and/or “?”. Exact matching and/or soft matching may be utilized.

In some implementations, a query may additionally and/or alternatively be identified as an interrogative query based on one or grammatical features of the query such as parts-of speech associated with one or more terms of the query, syntactic structure of the query, and/or semantic features of the query. For example, a query may be identified as an interrogative query based on matching a prefix or other segment of the query to one or more inquiry n-grams, and additionally matching one or more n-grams of the query to one or more additional terms. For instance, a query may be identified as an interrogative query if it includes the inquiry n-gram “how” and a “quantity” term such as “much”, “many”, “far”, etc. Also, for instance, a query may be identified as an interrogative query if it includes the inquiry n-gram “what” and a “location” term (e.g., “city”, “county”), a “person” term (e.g., “actor”, “politician”), and/or temporal term (e.g., “time”, “day”, “year”). In some implementations, a query may additionally and/or alternatively be identified as an interrogative query based on the user interface via which the query was submitted (e.g., some interfaces may be used solely for interrogative queries or are more likely to have interrogative queries submitted). In some implementations, a spoken query may additionally and/or alternatively be identified as an interrogative query based on voice inflection or other characteristic associated with the spoken query.

In some implementations, one or more rules-based approaches may implement one or more of the above considerations, and/or other considerations, in determining whether a query is an interrogative query. In some implementations, a classifier or other machine learning system may be trained to determine if a query is an interrogative query based on one or more of the above considerations, and/or other considerations.

The example environment of FIG. 1 includes a search system 110, a client device 106, an answer system 120, an annotator 130, a web resources database 156, and an entity database 152. The answer system 120 and/or other components of the example environment may be implemented in one or more computers that communicate, for example, through one or more networks. The answer system 120 is an example system in which the systems, components, and techniques described herein may be implemented and/or with which systems, components, and techniques described herein may interface. One or more components of the answer system 120, the search system 110, and/or the annotator 130 may be incorporated in a single system in some implementations.

A user may interact with the search system 110 and/or answer system 120 via the client device 106. While the user likely will operate a plurality of computing devices, for the sake of brevity, examples described in this disclosure will focus on the user operating client device 106. Moreover, while multiple users may interact with the search system 110 and/or answer system 120 via multiple client devices, for the sake of brevity, examples described in this disclosure will focus on a single user operating the client device 106. The client device 106 may be a computer coupled to the search system 110 through one or more networks 101 such as a local area network (LAN) or wide area network (WAN) (e.g., the Internet). The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. The client device 106 typically includes one or more applications to facilitate submission of search queries and the sending and receiving of data over a network. For example, the client device 106 may execute one or more applications, such as a browser or stand-alone search application, that allow users to formulate and submit queries to the search system 110 and receive answers and/or other search results in response to those queries.

Generally, the search system 110 receives search queries and returns information that is responsive to those search queries. As described in more detail herein, in some implementations the search system 110 may receive a search query 104 from the client device 106 and return to the client device 106 search results 108 that are responsive to the search query 104. In some of those implementations, the search query 104 may also be provided to the answer system 120 and the answer system 120 may determine one or more answers that are responsive to the search query 104. For example, in some implementations the search system 110 may determine if the query 104 is an interrogative query (e.g., based on one or more of the considerations described above) and, if so, provide the query 104 to the answer system 120. The one or more answers determined by the answer system 120 may be provided to the search system 110 for inclusion in the search results 108. For example, the search results 108 may include only the one or more answers, or may include the answers and other search results that are responsive to the search query 104.

As also described in more detail herein, in some implementations the search system 110 may receive a generated query 105 from answer system 120 and return, to the answer system 120, snippets 115 of one or more search result resources that are responsive to the query. In some implementations, the search system 110 may alternatively provide an indication of one or more search result resources that are responsive to the generated query 105, and the answer system 120 may itself identify snippets from those search result resources by accessing web resources database 156 and/or other database. As described herein, the snippets 115 may optionally be annotated with various types of grammatical information by annotator 130 prior to being provided to answer system 120. Additional description of the annotator 130 is provided below.

Each search query 104 is a request for information. The search query 104 can be, for example, in a text form and/or in other forms such as, for example, audio form and/or image form. Other computer devices may submit search queries to the search system 110 such as additional client devices and/or one or more servers implementing a service for a website that has partnered with the provider of the search system 110. For brevity, however, certain examples are described in the context of the client device 106.

The search system 110 includes an indexing engine 114 and a ranking engine 112. The indexing engine 114 maintains a web resources index 154 for use by the search system 110. The indexing engine 114 processes web resources (generally represented by web resources database 156) and updates index entries in the web resources index 154, for example, using conventional and/or other indexing techniques. For example, the indexing engine 114 may crawl the World Wide Web and index resources accessed via such crawling. Also, for example, the indexing engine 114 may receive information related to one or more resources from one or more sources such as web masters controlling such resources and index the resources based on such information. A resource, as used herein, is any Internet accessible document that is associated with a resource identifier such as, but not limited to, a uniform resource locator (“URL”), and that includes content to enable presentation of the document via an application executable on the client device 106. Resources include web pages, word processing documents, portable document format (“PDF”) documents, to name just a few. Each resource may include content such as, for example: text, images, videos, sounds, embedded information (e.g., meta information and/or hyperlinks); and/or embedded instructions (e.g., ECMAScript implementations such as JavaScript).

The ranking engine 112 uses the web resources index 154 to identify resources responsive to a search query, for example, using conventional and/or other information retrieval techniques. The ranking engine 112 calculates scores for the resources identified as responsive to the search query, for example, using one or more ranking signals.

In some implementations, ranking signals used by ranking engine 112 may include information about the search query 104 itself such as, for example, the terms of the query, an identifier of the user who submitted the query, and/or a categorization of the user who submitted the query (e.g., the geographic location from where the query was submitted, the language of the user who submitted the query, and/or a type of the client device 106 used to submit the query (e.g., mobile device, laptop, desktop)). For example, ranking signals may include information about the terms of the search query such as, for example, the locations where a query term appears in the title, body, and text of anchors in a resource, how a term is used in the resource (e.g., in the title of the resource, in the body of the resource, or in a link in the resource), the term frequency (i.e., the number of times the term appears in a corpus of resource in the same language as the query divided by the total number of terms in the resource), and/or the resource frequency (i.e., the number of resources in a corpus of resources that contain the query term divided by the total number of resources in the corpus).

Also, for example, ranking signals used by ranking engine 112 may additionally and/or alternatively include information about the resource such as, for example, a measure of the quality of the resource, a measure of the popularity of the resource, the URL of the resource, the geographic location where the resource is hosted, when the search system 110 first added the resource to the index 154, the language of the resource, the length of the title of the resource, and/or the length of the text of source anchors for links pointing to the resource.

The ranking engine 112 ranks the responsive resources using the scores. The search system 110 may use the responsive resources ranked by the ranking engine 112 to generate all or portions of search results 108 and/or snippets 115. For example, the search results 108 based on the responsive resources can include a title of a respective of the resources, a link to a respective of the resources, and/or a summary of content from a respective of the resources that is responsive to the search query 104. For example, the summary of content may include a particular “snippet” or section of a resource that is responsive to the search query 104.

Also, for example, the snippets 115 may include, for each of one or more responsive resources, one or more snippets from the title, body, or other portion of the resource. In some implementations, the one or more snippets provided for a resource may include the snippet(s) typically provided for the resource in search results 108 and/or snippets that include text that is in addition to the typically provided snippet(s). For instance, in some implementations the snippet for a resource may include the text typically provided in a search result for that resource, and additional text that precedes and/or follows such text. Various techniques may be utilized to determine a snippet to provide for a resource. For example, in some implementations the search system 110 may determine, for a given search query, the snippet for a resource based on a relationship between the snippet and the given search query (e.g., the same or similar terms occur in the snippet and the search query), a position of the snippet in the resource, formatting tags and/or other tags applied to the snippet, and/or other factors.

In some implementations, the snippets 115 provided by the search system 110 for a particular search query may include snippets from only a subset of the search result resources that are responsive to the search query. For example, as described herein, the ranking engine 112 calculates scores for the resources identified as responsive to a search query using one or more ranking signals—and the subset of the search result resources may be selected based on the scores. For example, those search result resources that have at least a threshold score may be included in the subset. Also, for example, the X (e.g., 2, 5, 10) search result resources with the best scores may be included in the subset. Also, for example, the search result resources that are the in the top X search result resources (as determined based on the scores) and that have at least a threshold score may be included in the subset.

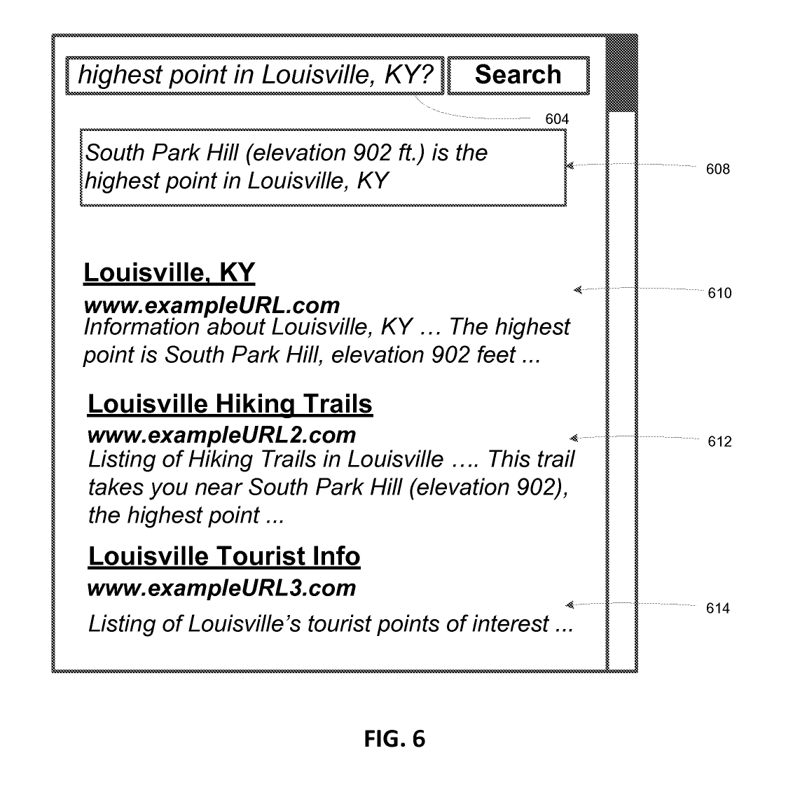

In implementations where the search system 110 provides an answer determined by answer system 120 in search results 108, the search results 108 may include only information related to the answer, or may include the answer in combination with one or more “traditional” search results based on the responsive resources identified by the ranking engine 112. For example, the search results illustrated in FIG. 6 are provided in response to search query 604 and include information 608 related to an answer in combination with search results 610, 612, 614 that are based on responsive resources to the search query 604. Referring again to FIG. 1, the search results 108 are transmitted to the client device 106 in a form that may be presented to the user. For example, the search results 108 may be transmitted as a search results web page to be displayed via a browser executing on the client device 106 and/or as one or more search results conveyed to a user via audio. In some implementations, the search system 110 provides the answer more prominently in the search results 108 and/or otherwise distinguished from other of the search results 108. For example, when the search results 108 are presented as a search results webpage, the answer may be displayed more prominently and/or may be positionally offset from other of the search results 108 as illustrated in FIG. 6.

Generally, answer system 120 determines answers to interrogative queries. In some implementations, the answer system 120 determines answers to interrogative queries that are submitted by users via computing devices of the users. For example, query 104 may be provided to the answer system 120 (via the client device 106 directly, and/or via the search system 110), and the answer system 120 may determine an answer for the query 104. The determined answer may be provided as all or part of search results 108 provided in response to the query 104. The search results 108 that include an answer may be provided to the client device 106 directly by the answer system 120 and/or provided by the answer system 120 to the search system 110 for inclusion in search results provided to the client device 106 by the search system 110.

In some implementations, the answer system 120: automatically formulates an interrogative query to identify missing information, verify existing information, and/or update existing information in entity database 152; determines one or more answers for the interrogative query; and uses the answers to modify the entity database 152. In some of those implementations, the determined answer may identify a particular entity and the modification may be a modification associated with the particular entity. For example, the answer system 120 may determine an answer that identifies the missing object entity in a (subject, relationship, object) triple of the entity database 152—and the answer may be utilized in populating the missing object entity in the triple in the entity database 152. In some implementations, the answer system 120 may utilize the determined answer to suggest a modification to the entity database 152 and the modification may only be made upon human approval. In some implementations, the answer system 120 may determine to modify the entity database 152 based on the determined answer and based on one or more additional signals.

Generally, entity database 152 may be a structured database that defines, for each of a plurality of entities, one or more relationships of that entity to attributes of that entity and/or to other related entities. For example, an entity associated with the U.S. president George Washington may have: a “born in” relationship to an entity associated with the State of Virginia; a “birthdate” relationship associated with the attribute Feb. 22, 1732; an “occupation” relationship to an entity associated with the President of the United States; and so forth. In some implementations entities are topics of discourse. In some implementations, entities are persons, places, concepts, and/or things that can be referred to by an alias (e.g., a term or phrase) and are distinguishable from one another (e.g., based on context). For example, the text “bush” on a webpage may potentially refer to multiple entities such as President George Herbert Walker Bush, President George Walker Bush, a shrub, and the rock band Bush. Also, for example, the text “sting” may refer to the musician Gordon Matthew Thomas Sumner or the wrestler Steve Borden. In some examples in this specification, an entity may be referenced with respect to a unique entity identifier. In some examples, the entity may be referenced with respect to one or more alias and/or other property of the entity.

As described above, answer system 120 determines answers to interrogative queries. In various implementations, answer system 120 may include an interrogative query engine 122, a candidate answers engine 124, and/or an answer(s) selection engine 126. In some implementations, all or aspects of engines 122, 124, and/or 126 may be omitted. In some implementations, all or aspects of engines 122, 124, and/or 126 may be combined. In some implementations, all or aspects of engines 122, 124, and/or 126 may be implemented in a component that is separate from answer system 120.

Generally, interrogative query engine 122 generates interrogative queries to provide to search system 110. For example, as illustrated in FIG. 1 interrogative query engine 122 may generate a generated query 105 that is provided to search system 110 to receive snippets 115 from one or more search result resources that are responsive to the generated query 105. In some implementations where the answering system determines answers to queries submitted by client device 106, the interrogative query engine 122 may be omitted (e.g., the submitted query itself may be used as the interrogative query). In some other implementations where the answering system determines answers to queries submitted by client device 106, the interrogative query engine 122 may optionally generate one or more rewrites of the query submitted by the client device 106. The one or more rewrites may be submitted to the search system 110 in addition to (or alternatively to) the submitted query to receive snippets 115 that are responsive to the rewrites. For example, the interrogative query engine 122 may rewrite the query to expand the query, condense the query, replace one or more terms with synonyms of those terms, etc. For instance, the query 104 may be “bart simpson's sisters?”, and the interrogative query engine 122 may generate one or more rewrites such as “who are bart simpson's sisters”. Also, for instance, the query 104 may be “tallest point in Louisville, Ky.” and the interrogative query engine 122 may generate one or more rewrites such as “what is the highest point in Louisville, Ky.”, “tallest peak in Louisville, Ky.”, and/or “what location has the highest elevation in Louisville, Ky.”.

In some implementations, the interrogative query engine 122 generates interrogative queries to identify missing information, verify existing information, and/or update existing information in the entity database 152. For example, the interrogative query may be formulated based on identified “missing” information in the entity database 152. For example, the interrogative query may be formulated based on a missing element of a triple (subject, relationship, object) of the entity database 152. For instance, the subject of the triple may be a known entity, the relationship may be “is married to” and the object may be the missing element. Based on such triple, an interrogative query of “Who is [alias of entity] married to” may be formulated. In various implementations, multiple interrogative queries may optionally be generated. For instance, “who is [alias of entity]'s spouse”, “who is [entity]'s wife”, “who is [entity]'s husband”, etc. may also be generated. As described below, the engines 124 and 126 may utilize textual snippets from search result resources that are responsive to a generated query 105 to determine an answer to the interrogative query, and the answer may be utilized in defining, in the entity database 152, the missing element in the triple.

As another example, assume the cartoon character “Ned Flanders” is a known entity in the entity database 152, and the entity database 152 defines a “children” relationship for “Ned Flanders” to the entities associated with the cartoon characters “Rod Flanders” and “Todd Flanders”. The interrogative query engine 122 may generate or more interrogative queries based on the subject (Ned Flanders) and the relationship (children) of the triple, such as the query: “who are ned flanders' children”. As described below, the engines 124 and 126 may utilize textual snippets from search result resources that are responsive to the generated interrogative queries to determine an answer to the interrogative query, and use the answer to verify and/or increase the confidence in the entity database 152, of the “children” relationship for “Ned Flanders”.

Generally, candidate answers engine 124 determines candidate answers for an interrogative query based on snippets from one or more search result resources that are responsive to the interrogative query (or responsive to one or more multiple interrogative queries if multiple interrogative queries are generated by interrogative query engine 122). As described above with respect to search system 110, a search may be performed based on an interrogative query provided by the client device 106 and/or the answer system 120. Snippets 115 from one or more of the search result resources that are responsive to the query may further be provided by search system 110 to answer system 120. In some implementations, the search system 110 may provide an indication of the responsive search result resources to the answer system 120 and the answer system 120 may identify the snippets from the resources.

In some implementations, the snippet(s) for a resource may include snippet(s) that would normally be selected for presentation with a search result based on the resource. In some implementations, the snippet(s) may include additional and/or alternative textual segments (e.g., longer snippets than those normally selected for presentation with search results). In some implementations, the snippets may be selected from a subset of search result resources such as the X resources having the highest ranking for the interrogative query, the resources having at least a threshold score for the interrogative query, and/or based on other measures associated with the resources (e.g., overall popularity measures of the resources).

The candidate answers engine 124 may utilize various techniques to determine candidate answers for the query based on the identified snippets. For example, the snippets 115 may be annotated with grammatical information by annotator 130 to form annotated snippets 116, and the candidate answers engine 124 may determine one or more candidate answers based on the annotations of the annotated snippets 116.

The annotator 130 may be configured to identify and annotate various types of grammatical information in one or more textual segments of a resource. For example, the annotator 130 may include a part of speech tagger configured to annotate terms in one or more segments with their grammatical roles. For example, the part of speech tagger may tag each term with its part of speech such as “noun,” “verb,” “adjective,” “pronoun,” etc. Also, for example, in some implementations the annotator 130 may additionally and/or alternatively include a dependency parser configured to determine syntactic relationships between terms in one or more segments. For example, the dependency parser may determine which terms modify other terms, subjects and verbs of sentences, and so forth (e.g., a parse tree)—and may make annotations of such dependencies.

Also, for example, in some implementations the annotator 130 may additionally and/or alternatively include an entity tagger configured to annotate entity references in one or more segments such as references to people, organizations, locations, and so forth. For example, the entity tagger may annotate all references to a given person in one or more segments of a resource. The entity tagger may annotate references to an entity at a high level of granularity (e.g., to enable identification of all references to an entity type such as people) and/or a lower level of granularity (e.g., to enable identification of all references to a particular entity such as a particular person). The entity tagger may rely on content of the resource to resolve a particular entity and/or may optionally communicate with entity database 152 or other entity database to resolve a particular entity. Also, for example, in some implementations the annotator 130 may additionally and/or alternatively include a coreference resolver configured to group, or “cluster,” references to the same entity based on one or more contextual cues. For example, “Daenerys Targaryen,” “Khaleesi,” and “she” in one or more segments may be grouped together based on referencing the same entity. In some implementations, the coreference resolver may use data outside of a textual segment (e.g., metadata or entity database 152) to cluster references.

In some implementations, one or more components of the annotator 130 may rely on annotations from one or more other components of the annotator 130. For example, in some implementations the named entity tagger may rely on annotations from the coreference resolver and/or dependency parser in annotating all mentions to a particular entity. Also, for example, in some implementations the coreference resolver may rely on annotations from the dependency parser in clustering references to the same entity.

As an example of candidate answers engine 124 utilizing one or more annotations to determine a candidate answer, the interrogative query may seek a certain type of information and only terms that conform to that information type may be identified as candidate answers. For instance, for an interrogative query that contains “where”, only terms that are annotated as “locations” may be identified as candidate answers. Also, for instance, for an interrogative query that contains “who”, only terms that are annotated as “people” may be identified. Also, for instance, for an interrogative query formulated based on a triple relationship of “is born on”, candidate answers engine 124 may identify only terms that are annotated as “dates”.

As another example, only terms that have a certain syntactic relationship to other terms of the query (e.g., positional and/or in a parse tree) in the snippet may be identified as candidate answers by the candidate answers engine 124. For instance, only terms that appear in the same sentence of a snippet as the alias of the entity named in the interrogative query may be identified as candidate answers. For instance, for a query of “who are ned flander's sons”, only terms that appear in the same sentence of the snippet as “Ned Flander” may be identified as candidate answers. Also, for example, for certain interrogative queries only terms that are the “object” of a sentence of a snippet (e.g., as indicated by a parse tree) may be identified as candidate answers. It is noted that candidate answers engine 124 may optionally identify multiple candidate answers from a single snippet for many interrogative queries. For instance, a query of the form “who are [alias of entity]'s children” may return multiple candidate answers from a single snippet.

In some implementations, the candidate answers engine 124 may be a system that has been trained to determine candidate answers. For example, machine learning techniques may be utilized to train the candidate answers engine 124 based on labeled data. The candidate answers engine 124 may, for example, be trained to receive, as input, one or more features related to a snippet and/or an interrogative query to which the snippet is responsive and provide, as output, one or more candidate answers.

Generally, answer(s) selection engine 126 selects one or more of the candidate answers determined by the candidate answers engine 124. For example, the answer(s) selection engine 126 may select one or more candidate answers based on scores associated with the candidate answers. For instance, only the answer with the “best” score may be selected and/or only those answers that have a score that satisfies a threshold may be selected. The score of a candidate answer is generally indicative of confidence the candidate answer is the correct answer. Various techniques may be utilized by the candidate answers engine 124 and/or the answer(s) selection engine 126 to determine the score. For example, the score for a candidate answer may be based on heuristics, which in turn are based on the snippet(s) of text from which the candidate answer was determined. Also, for example, the score for a candidate answer may be based on a count of the identified textual snippets that include a reference to the candidate answer and/or a count of the resources that include a textual snippet that includes a reference to the candidate answer (e.g., inclusion in snippets from 10 resources may result in a score more indicative of being a correct answer than inclusion in snippets from only 5 resources). Also, for example, the score for a candidate answer may be based on one or more measures associated with the search result resources that include the identified textual snippets with a reference to the candidate answer. The measure(s) for a search result resource may be based on, for example, an overall popularity measure of the resource (which may be independent of the query), a ranking of the resource for the query (e.g., as determined by ranking engine 112), and/or a date the resource was created and/or modified (e.g., more current resources may be favored in some situations).

Also, for example, where a system is trained to determine candidate answers (as described above with respect to candidate answers engine 124), the system may further be trained to determine scores that are indicative of confidence in the candidate answers. For instance, the system may be trained to receive, as input, one or more features related to the snippet and/or the interrogative query an interrogative query to which the snippet is responsive and provide, as output, one or more candidate answers and scores for the candidate answers.

It is noted that for some interrogative queries the answer(s) selection engine 126 may select multiple answers (e.g., who are X's children) and that for others only a single answer may be selected (e.g., where was X born). Thus, in some implementations the answer(s) selection engine 126 may determine a quantity of answers to select as answers to an interrogative query based on the interrogative query. For example, for interrogative queries that are formulated to determine a place where a person was born (e.g., to determine a missing object in a triple that has a “born in” relationship), only a single answer may be selected by the answer(s) selection engine 126. It is also noted that for some interrogative queries the answer(s) selection engine 126 may not select any answers. For example, the selection engine 126 may not select any answers based on the scores for all of the candidate answers failing to satisfy a threshold.

In implementations where an answer is determined based on an interrogative query received from the client device 106, the answer system 120 may provide the determined answer to the query to client device 106 (optionally via search system 110) for presentation to a user of the client device 106. For example, the answer may be provided audibly to the user and/or presented in a graphical user interface to the user. Additional information about the answer and/or the resource(s) on which the answer is based (e.g., one or more of the resources that included the snippets from which the answer was determined) may also optionally be provided. Also, the answer may optionally be placed in a textual segment to make it responsive to the interrogative query. For example, the answer may be incorporated with one or more segments of the interrogative query to make the presentation of the answer more “conversational”. As one example of additional information that may be included with the answer, FIG. 6 illustrates the answer (South Park Hill) included with “(elevation 902 ft.)”, which may be determined as additional relevant information based on the snippets, the interrogative query 604, and/or other factors. FIG. 6 also illustrates the answer (South Park Hill) included with segments of the interrogative query (“is the highest point in Louisville, Ky.”) to make presentation of the answer more conversational.

In implementations where an answer is determined based on an interrogative query formulated based on information that is absent from the entity database 152, the answer may be defined as the absent information in the entity database 152. For example, the interrogative query may be formulated based on an absent element of a triple (subject, relationship, object). For instance, the subject of the triple may be a known entity, the relationship may be “is married to” and the object may be the absent element. An association of the known entity to the answer for the “is married to” relationship may be defined in the entity database 152.

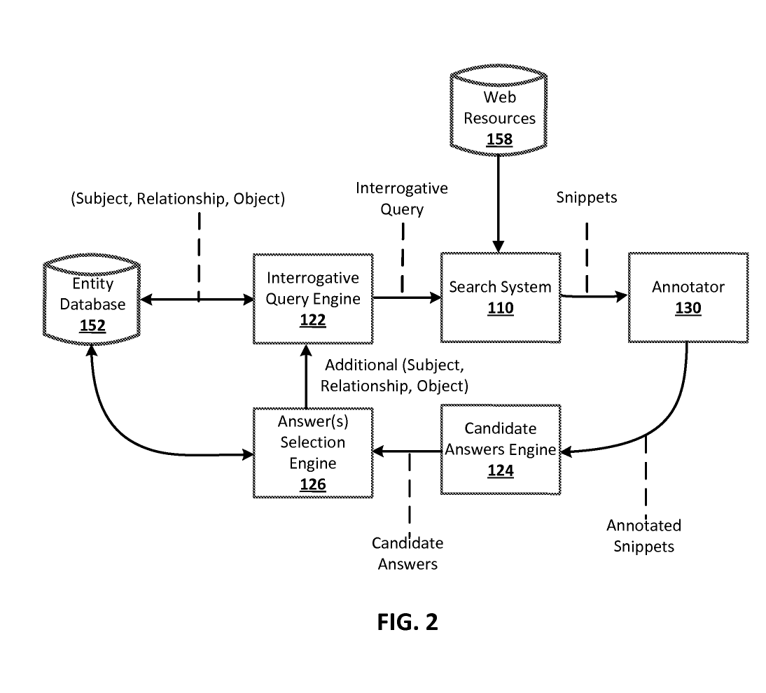

As described in more detail below with respect to FIG. 2, in some implementations an answer may be an answer that is resolved to a particular entity. For instance, in some implementations the annotations provided by annotator 130 may resolve a term to a particular entity and the resolved entity may be utilized as the answer. Also, for instance, the answer could be an ambiguous term that potentially refers to multiple entities defined in the entity database 152, or the answer could relate to an entity that is not yet defined in the entity database 152. In some of those implementations, various techniques may be utilized by answer system 120 to disambiguate the answer and/or determine whether the answer references a previously undefined entity that should be considered for inclusion in the entity database. For instance, where the answer is ambiguous and potentially refers to multiple entities, interrogative query engine 122 may generate additional queries based on the answer to resolve the answer to a particular entity. Also, for instance, where the answer is undefined in the entity database 152, interrogative query engine 122 may generate additional queries based on the answer to determine if additional relationships of the answer (to other known entities and/or to attributes of the answer) may be determined. If at least a threshold quantity of additional relationships are determined and/or those additional relationships are determined with at least a threshold level of confidence, the answer may be automatically included as a new entity in the entity database 152 and/or provided for potential consideration for inclusion in the entity database 152 (e.g., only included upon review by one or more individuals and/or after further processing by one or more separate computing systems).

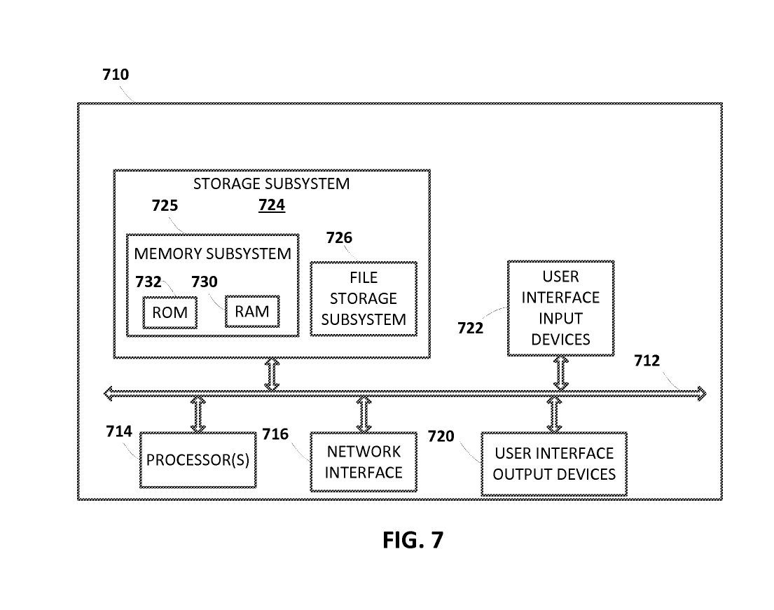

The components of the example environment of FIG. 1 may each include memory for storage of data and software applications, a processor for accessing data and executing applications, and components that facilitate communication over a network. In some implementations, such components may include hardware that shares one or more characteristics with the example computer system that is illustrated in FIG. 7. The operations performed by one or more components of the example environment may optionally be distributed across multiple computer systems. For example, the steps performed by the answer system 120 may be performed via one or more computer programs running on one or more servers in one or more locations that are coupled to each other through a network. In this specification, the term “database” will be used broadly to refer to any collection of data. The data of the database does not need to be structured in any particular way, or structured at all, and it can be stored on storage devices in one or more locations. Thus, for example, the database may include multiple collections of data, each of which may be organized and accessed differently.

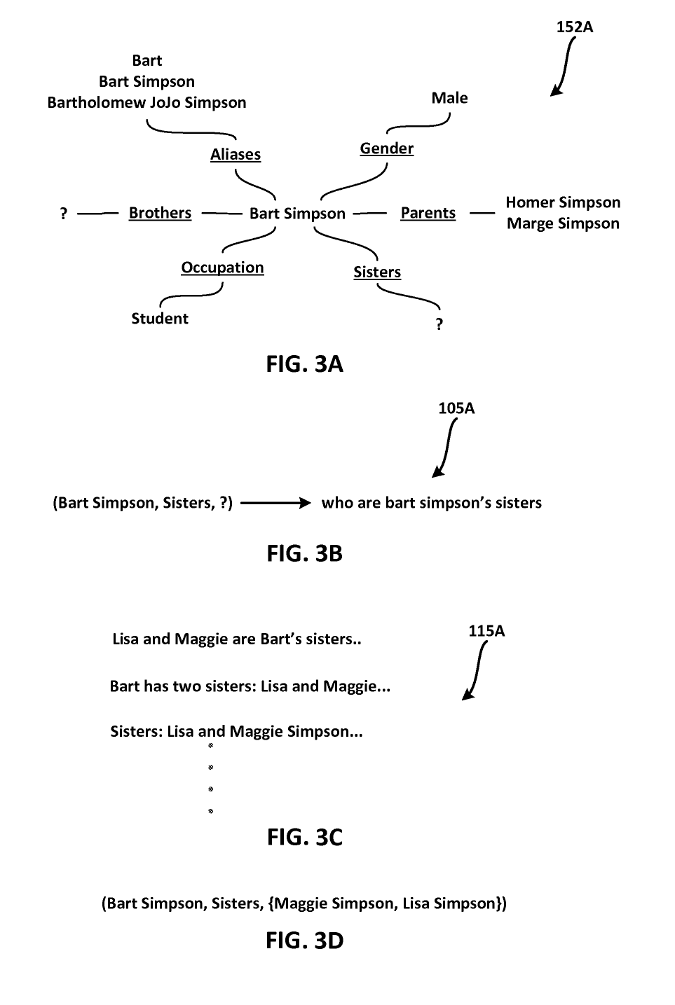

FIG. 2 illustrates an example of automatically formulating an interrogative query to identify missing information, verify existing information, and/or update existing information in the structured entity database 152; determining one or more answers for the interrogative query; and using the answers to modify the entity database 152. To aid in explaining the example of FIG. 2, reference will also be made to FIGS. 3A-3D.

Interrogative query engine 122 formulates an interrogative query based on information in entity database 152. For example, the interrogative query may be formulated based on a missing element of a triple (subject, relationship, object) in the entity database 152. For instance, FIG. 3A schematically illustrates an example portion 152A of entity database 152. The portion 152A includes an entity associated with the cartoon character “Bart Simpson” and shows additional attributes and entities associated with “Bart Simpson” for various relationships (the relationships are indicated with underlining in FIG. 3A). For example, the entity associated with “Bart Simpson” has: a “parents” relationship to entities associated with the cartoon characters Homer and Marge Simpson; a “gender” relationship to an entity associated with “male”; an “occupation” relationship to an entity associated with “student”; and an “aliases” relationship to the attributes of “Bart”, “Bart Simpson”, and “Bartholomew JoJo Simpson”. Notably, the entity associated with “Bart Simpson” does not have any association to another entity for the “sisters” and “brothers” relationships. The interrogative query engine 122 may generate one or more interrogative queries based on the missing element of the triple (Bart Simpson, Sisters, ?), such as the queries: “Who is Bart Simpson's sister?”, “Who are Bart Simpson's Sisters” (illustrated as generated query 105A in FIG. 3B), and/or “Who are Bart's sisters”. The queries may be generated, for example, based on including aliases associated with “Bart Simpson” as terms in the query (e.g., as indicated by the aliases relationship of FIG. 3A) and including terms associated with the “sisters” relationship as terms in the query.

The interrogative query is provided to the search system 110. As described above, the search system 110 identifies one or more search result resources that are responsive to the query. The search system 110 further identifies snippets of one or more search result resources via web resources index 154 and/or using web resources database 156. For example, the snippets 115A of FIG. 3C and additional snippets (indicated by the vertical dots in FIG. 3C) may be identified.

The snippets are provided to annotator 130. As described above, the annotator 130 may be configured to identify and annotate various types of grammatical information in one or more textual segments of a resource. The annotator 130 may provide the annotated snippets to the candidate answers engine 124.

The candidate answers engine 124 determines candidate answers based on the snippets utilizing one or more techniques. For example, for the generated query 105A of FIG. 3B, the candidate answers engine 124 may determine that only terms annotated as a “person” should be identified (e.g., based on the presence of “who” and/or “sisters” in the interrogative query). Also, for example, the candidate answers engine 124 may determine that only terms that appear within a threshold distance of an alias of “Bart Simpson” and/or have a parse tree relationship to such an alias may be identified as candidate answers. Based on these and/or other determinations, the candidate answers engine 124 may identify “Maggie” and “Lisa” as candidate answers. In some implementations, the candidate answers may be resolved to particular entities. For example, the candidate answers may be resolved to the entities associated with the cartoon characters “Maggie Simpson” and “Lisa Simpson” based on annotations provided by annotator 130.

The candidate answers are provided to answer(s) selection engine 126, which selects one or more of the candidate answers determined by the candidate answers engine 124. For example, the answer(s) selection engine 126 may select both “Maggie” and “Lisa” based on scores associated with those candidate answers. For instance, both of those answers may have a score that satisfies a threshold. Various techniques may be utilized to determine the score. For example, the score for a candidate answer may be based on heuristics, a count of the identified textual snippets that include a reference to the candidate answer, and/or a count of the resources that include a textual snippet that includes a reference to the candidate answer. Also, for example, the score for a candidate answer may be based on one or more measures associated with the search result resources that include the identified textual snippets with a reference to the candidate answer.

The answer(s) selection engine 126 may utilize the selected answer(s) to define the missing information in the entity database 152. For example, as illustrated by the triple in FIG. 3D, an association between the entity associated with “Bart Simpson” and the entities associated with “Maggie Simpson” and “Lisa Simpson” may be defined in the entity database 152 for the relationship of “sisters”. In some implementations, the answers may be resolved to particular entities. For example, the answers may be resolved to the entities associated with the cartoon characters “Maggie Simpson” and “Lisa Simpson” based on annotations provided by annotator 130.

In some implementations, further processing of an answer to missing information may be performed to resolve the answer to a particular entity and/or determine if the answer relates to an entity that should be provided for potential inclusion in the entity database 152. For instance, the answer could be an ambiguous term that potentially refers to multiple entities defined in the entity database 152, or the answer could relate to an entity that is not yet defined in the entity database 152. In some of those implementations, answer(s) selection engine 126 may utilize various techniques to disambiguate the answer and/or determine whether the answer references a previously undefined entity that should be considered for inclusion in the entity database. For instance, additional queries may be generated based on the answer to resolve the answer to a particular entity (as illustrated in FIG. 2 by the arrow extending between answer(s) selection engine 126 and interrogative query engine 122).

As one example, assume as described above that the cartoon character “Bart Simpson” is a known entity in an entity database, but the database does not define an object for the relationship “sister”. One or more interrogative queries may be formulated based on the subject (Bart Simpson) and the relationship (sister). Textual snippets from search results that are responsive to the interrogative query may be identified and utilized to determine answers to the interrogative query. For instance, multiple textual snippets may indicate Bart Simpson's sisters are “Lisa Simpson” and “Maggie Simpson”.

Further assume “Maggie Simpson” is not associated with a defined entity in the entity database. Interrogative query engine 122 may generate one or more additional interrogative queries that are based on the answer (and optionally the subject and/or relationship on which the question was determined) to determine one or more relationships of the entity based on web resources. For instance, additional interrogative queries may be formulated to determine relationships of “Maggie Simpson” to other attributes and/or entities, such as “Where was Maggie Simpson, sister of Bart Simpson, born” (to determine a relationship to a “place of birth”), “Who are Bart and Maggie Simpson's parents” (to determine a relationship to “parents”), “What is the birthday of Maggie Simpson, sister of Bart Simpson”, etc. It is noted the preceding example queries are based on the subject and relationship on which the questions was determined (i.e., they all include “sister of Bart Simpson”). In some implementations this may be desirable to increase the likelihood that search result resources that are responsive to the query relate to the same entity of the answer. Snippets responsive to such queries may be processed by candidate answers engine 124 and answers selection engine 126 as described above to determine one or more answers for such queries. If such additional interrogative queries identify at least a threshold number of relationships of “Maggie Simpson” to attributes and/or other known entities, and/or identify the relationships with at least a threshold level of confidence, “Maggie Simpson” may be automatically added to the entity database 152, or flagged for potential addition to the entity database 152.

Similar techniques may be utilized to disambiguate an answer that refers to multiple entities. For example, assume the cartoon character “Maggie Simpson” is a known entity in the entity database 152. However, further assume there is a real life actor by the name of Maggie Simpson that is also a known entity in the entity database 152. The occurrence of “Maggie Simpson” may be resolved to the cartoon character based on one or more interrogative queries formulated to verify known triples related to the cartoon character. The interrogative queries may optionally also be based on the subject and/or relationship on which the question was determined. For example, a triple in the structured database that is related to the cartoon character may be (Maggie Simpson, born in, Springfield) and a triple that is related to the real life actor may be (Maggie Simpson, born in, Albuquerque). An interrogative query may be generated such as “Where was Maggie Simpson, brother of Bart Simpson, born”. Snippets from search results of the additional interrogative queries may be analyzed to determine “Springfield” is the correct answer to the interrogative query. Based on “Springfield” being the correct answer, the cartoon character Maggie Simpson may be selected as the appropriate entity (since Springfield is indicated in the entity database 152 as the place of birth of the cartoon character Maggie Simpson).

It is noted that although many examples herein describe one or more candidate answers being identified and one or more of the candidate answers being selected, some interrogative queries may not result in candidate answers being identified and/or candidate answers being selected. For example, in FIG. 3A the entity associated with “Bart Simpson” does not have any association to another entity for the “brothers” relationships. The interrogative query engine 122 may generate one or more interrogative queries based on the missing element of the triple (Bart Simpson, brothers, ?), such as the query: “Who is Bart Simpson's brother?”. Since the cartoon character Bart Simpson does not have a brother (or a brother was only hinted at in limited episodes), an answer may not be selected for such a query. For example, the search system 110 may not provide snippets based on search result resources for such a query failing to have at least a threshold score for the query, candidate answers may not be identified based on provided textual snippets according to techniques described herein, and/or none of the candidate answers may be selected based on scores of the candidate answers all failing to satisfy a threshold.

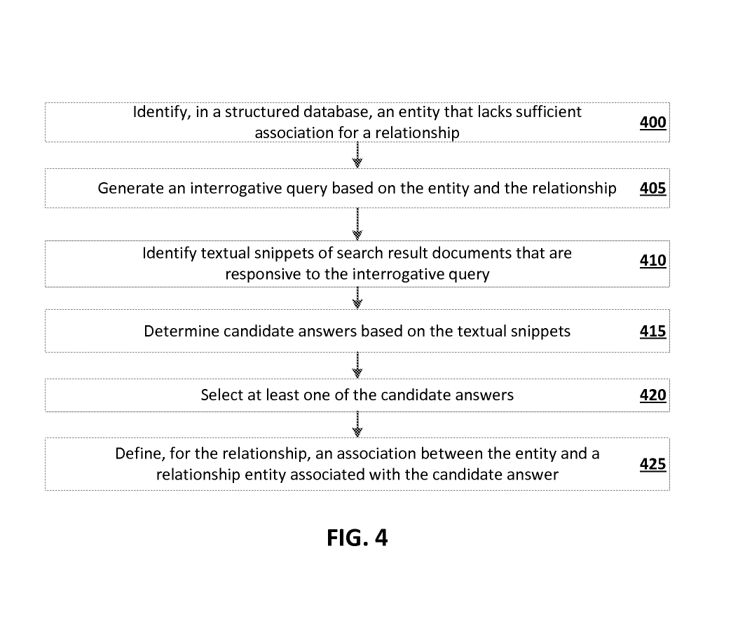

FIG. 4 is a flow chart illustrating an example method of formulating an interrogative query based on information in a structured entity database, determining one or more answers for the interrogative query, and using the answers to modify the entity database. Other implementations may perform the steps in a different order, omit certain steps, and/or perform different and/or additional steps than those illustrated in FIG. 4. For convenience, aspects of FIG. 4 will be described with reference to a system of one or more computers that perform the process. The system may include, for example, one or more of the engines 122, 124, and 126 of answer system 120.

At step 400, an entity that lacks sufficient association for a relationship is identified in a structured database. For example, the system may identify absent information in a structured database, such as entity database 152. For example, the system may identify a missing element of a triple (subject, relationship, object) of the entity database 152. For instance, the subject of the triple may be a known entity, the relationship may be “is married to” and the object may be the missing element.

At step 405, an interrogative query is generated based on the entity and the relationship. For example, the system may generate the interrogative query may be generated to include one or more aliases of the entity, and one or more terms mapped to the relationship. For example, if the entity is associated with the cartoon character “Bart Simpson”, the aliases included in the interrogative query may be “Bart” and/or “Bart Simpson”. Also, for example, if the relationship is “sisters”, the terms may be “sister”, “sister”, and/or “who” (who may be mapped to the relationship of sister since the relationship is looking for an object that is a “person”).

At step 410, textual snippets of search result documents that are responsive to the interrogative query are identified. For example, a search may be performed based on the interrogative query and snippets from one or more of the search result resources that are responsive to the query may be identified. In some implementations, the snippets may be provided by a search system that performs the search based on the interrogative query. In some implementations, the search system may provide an indication of the responsive search result resources and the snippets may identify the snippets from the responsive search result resources.

At step 415, candidate answers are determined based on the textual snippets. The system may utilize various techniques to determine candidate answers for the query based on the identified snippets. For example, the snippets may be annotated with grammatical information by annotator 130 to form annotated snippets, and the system may determine one or more candidate answers based on the annotations of the annotated snippets. As an example of the system utilizing one or more annotations to determine a candidate answer, the interrogative query may seek a certain type of information and only terms that conform to that information type may be identified as candidate answers. For instance, for an interrogative query that contains “where”, only terms that are annotated as “locations” may be identified as candidate answers. Also, for instance, for an interrogative query formulated based on a triple relationship of “is born on”, the system may identify only terms that are annotated as “dates”.

At step 420, at least one of the candidate answers is selected. For example, the system may select one or more candidate answers based on scores associated with the candidate answers. Various techniques may be utilized to determine the score. For example, the score for a candidate answer entity may be based on heuristics, a count of the identified textual snippets that include a reference to the candidate answer, and/or a count of the resources that include a textual snippet that includes a reference to the candidate answer. Also, for example, the score for a candidate answer may be based on one or more measures associated with the search result resources that include the identified textual snippets with a reference to the candidate answer.

At step 425, an association between the entity and a relationship entity associated with the candidate answer is defined for the relationship. For example, where an answer is determined based on an interrogative query formulated based on information that is absent from the entity database 152, a relationship entity associated with the answer may be defined as the absent information in the entity database 152. For example, the interrogative query may be formulated based on an absent element of a triple (subject, relationship, object). For instance, the subject of the triple may be a known entity, the relationship may be “is married to” and the object may be the absent element. An association of the known entity to a relationship entity associated with the selected answer for the “is married to” relationship may be defined in the entity database 152.

As described herein, in some implementations a selected answer may be one that is resolved to a particular entity. For instance, in some implementations the annotations provided by annotator 130 may resolve a term to a particular entity and the resolved entity may be utilized as the relationship entity. In some implementations, an answer may be an ambiguous term that potentially refers to multiple entities defined in the entity database 152, or the answer could relate to an entity that is not yet defined in the entity database. In some of those implementations, various techniques may be utilized by the system to disambiguate the answer to the relationship entity and/or determine whether the answer references a previously undefined entity that should be considered for inclusion in the entity database.

The steps of FIG. 4 may be repeated for one or more relationships of multiple entities that lack a sufficient association. For example, the steps of FIG. 4 may be repeated for additional relationships and entities to expand and/or update the defined entity relationships included in the entity database 152. In some implementations, the steps of FIG. 4 and/or other steps may be performed on a periodic or other basis to expand and/or update the defined entity relationships included in the entity database 152.

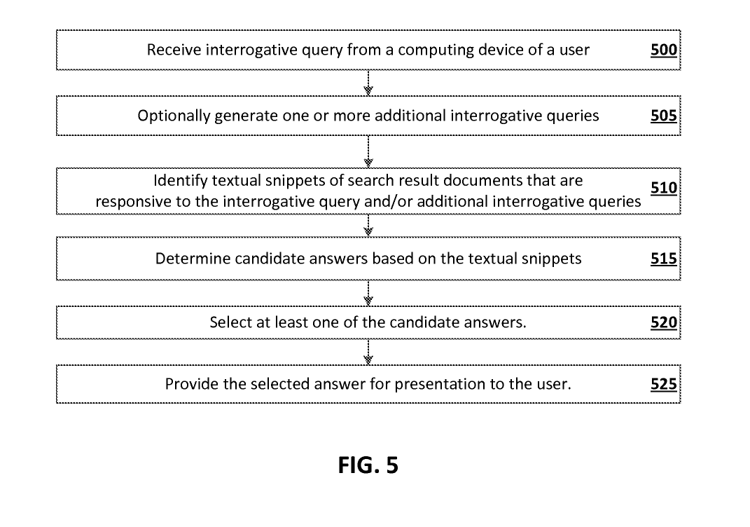

FIG. 5 is a flow chart illustrating an example method of determining one or more answers to an interrogative query submitted from a computing device of a user, and providing the answers for presentation to the user. Other implementations may perform the steps in a different order, omit certain steps, and/or perform different and/or additional steps than those illustrated in FIG. 5. For convenience, aspects of FIG. 5 will be described with reference to a system of one or more computers that perform the process. The system may include, for example, one or more of the engines 122, 124, and 126 of answer system 120.

At step 500, an interrogative query is received from a computing device of a user.

At step 505, one or more additional interrogative queries are optionally generated based on the interrogative query received at step 500. For example, the system may optionally generate one or more rewrites of the query submitted by the client device 106. For example, the system may rewrite the query to expand the query, condense the query, replace one or more terms with synonyms of those terms, etc. The one or more rewrites may be submitted to a search in addition to (or alternatively to) the received interrogative query to receive snippets that are responsive to the rewrites.

At step 510, textual snippets of search result documents that are responsive to the interrogative query and/or the additional interrogative queries are identified. For example, a search may be performed based on the interrogative query and snippets from one or more of the search result resources that are responsive to the query may be identified. Step 510 and step 410 (FIG. 4) may include one or more aspects in common.

At step 515, candidate answers are determined based on the textual snippets. The system may utilize various techniques to determine candidate answers for the query based on the identified snippets. For example, the snippets may be annotated with grammatical information by annotator 130 to form annotated snippets, and the system may determine one or more candidate answers based on the annotations of the annotated snippets. Step 515 and step 415 (FIG. 4) may include one or more aspects in common.

At step 520, at least one of the candidate answers is selected. For example, the system may select one or more candidate answers based on scores associated with the candidate answers. Various techniques may be utilized to determine the score. For example, the score for a candidate answer entity may be based on heuristics, a count of the identified textual snippets that include a reference to the candidate answer, and/or a count of the resources that include a textual snippet that includes a reference to the candidate answer. Step 520 and step 420 (FIG. 4) may include one or more aspects in common.

At step 525, the selected answer is provided for presentation to the user. For example, the selected answer may be provided to the computing device from which the interrogative query was received and/or an additional computing device associated with the user. The determined answer may be provided for visual and/or audible presentation to the user in response to the interrogative query. As one example, the selected answer may be provided for transmission to the client device 106 as part of search results in a form that may be presented to the user. For example, the answer may be provided to search system 110 and transmitted by search system 110 as a search results web page to be displayed via a browser executing on the client device 106 and/or as one or more search results conveyed to a user via audio. The search results may include only the answer(s) (and optionally additional information related to the answer) or may include the answer in combination with one or more search results based on the responsive documents identified by the ranking engine 112. For example, the search results illustrated in FIG. 6 are provided in response to search query 604 and include information 608 related to an answer in combination with search results 610, 612, 614 that are based on the resources responsive to the search query 604.

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface input devices 722, user interface output devices 720, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to perform one or more of the methods described herein such as, for example, the methods of FIGS. 4 and/or 5.

These software modules are generally executed by processor 714 alone or in combination with other processors. Memory 725 used in the storage subsystem can include a number of memories including a main random access memory (RAM) 730 for storage of instructions and data during program execution and a read only memory (ROM) 732 in which fixed instructions are stored. A file storage subsystem 724 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 724 in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
determining an entity lacks sufficient association in a structured database for a relationship;
generating at least one interrogative query based on the entity and the relationship;
identifying textual snippets of search result resources that are responsive to the interrogative query;
determining, based on the textual snippets, one or more candidate answers for the interrogative query;
selecting at least one answer of the candidate answers; and
defining an association for the relationship in the structured database, the association being between the entity and a relationship entity associated with the answer.

2. The method of claim 1, wherein the answer is associated with the relationship entity in one or more annotations associated with the textual snippets.

3. The method of claim 1, further comprising:
determining the relationship entity is previously undefined in the structured database;
generating at least one additional interrogative query based on the relationship entity and an additional relationship;
determining, based on content of additional search result resources that are responsive to the additional interrogative query, at least one additional relationship entity that is distinct from the entity and distinct from the relationship entity; and
defining, in the structured database, an additional association between the relationship entity and the additional relationship entity for the additional relationship.

4. The method of claim 3, wherein determining the at least one additional relationship entity comprises:
identifying additional textual snippets of the additional search result resources;
determining, based on the additional textual snippets, one or more candidate additional relationship entities that include the additional relationship entity; and
selecting the additional relationship entity from the candidate additional relationship entities.

5. The method of claim 1, further comprising:
determining the relationship entity is previously undefined in the structured database;
generating at least one additional query based on the relationship entity; and
determining, based on content of one or more additional search result resources that are responsive to the additional query, that the relationship entity is a valid entity;
wherein defining the association between the entity and the relationship entity for the relationship occurs based on determining that the relationship entity is a valid entity.

6. The method of claim 5, wherein the at least one additional query is generated based on an additional relationship and wherein determining the relationship entity is a valid entity comprises:
determining, based on textual snippets of the additional search result resources that are responsive to the query, an association between the relationship entity and at least one additional relationship entity, the additional relationship entity distinct from the entity and distinct from the relationship entity.

7. The method of claim 1, further comprising:
identifying an additional relationship of the relationship entity and an additional relationship entity associated with the relationship entity for the additional relationship;
generating at least one additional query based on the relationship entity, the additional relationship, and the entity; and
determining occurrence of the additional relationship entity in additional search result resources that are responsive to the additional query;
wherein defining the association between the entity and the relationship entity is based on occurrence of the additional relationship entity in the additional search result resources.

8. The method of claim 7, wherein generating the additional query is further based on the relationship.

9. The method of claim 1, wherein generating the interrogative query based on the entity and the relationship comprises:
generating one or more first terms of the query based on an alias of the entity and generating one or more second terms of the query based on terms mapped to the relationship.

10. The method of claim 1, wherein identifying the textual snippets of the search result resources, comprises:
identifying the snippets based on the snippets including at least one of: an alias of the entity, and a term associated with a grammatical characteristic that is mapped to the relationship.

11. The method of claim 1, wherein identifying the textual snippets of the search result resources, comprises:
receiving the snippets from a search system in response to submitting the interrogative query to the search system.

12. The method of claim 1, wherein determining, based on the textual snippets, one or more candidate relationship entities that are each distinct from the entity comprises:
determining the candidate relationship entities based on the candidate relationship entities each being associated with a grammatical characteristic that is mapped to the relationship.

13. The method of claim 1, wherein selecting at least one relationship entity of the candidate relationship entities comprises:
selecting the relationship entity based on a count of the identified textual snippets that include a reference to the relationship entity.

14. The method of claim 1, wherein selecting at least one relationship entity of the candidate relationship entities comprises:
selecting the relationship entity based on a count of the search result resources that include the identified textual snippets that include a reference to the relationship entity.

15. The method of claim 1, wherein selecting at least one relationship entity of the candidate relationship entities comprises:
selecting the relationship entity based on measures associated with the search result resources that include the identified textual snippets that include a reference to the relationship entity.

16. A system, comprising:
memory storing instructions;
one or more processors operable to execute the instructions stored in the memory;
wherein the instructions comprise instructions to:
determine an entity lacks sufficient association in a structured database for a relationship;
generate at least one interrogative query based on the entity and the relationship;
identify textual snippets of search result resources that are responsive to the interrogative query;
determine, based on the textual snippets, one or more candidate relationship entities that are each distinct from the entity;
select at least one relationship entity of the candidate relationship entities; and
define, in the structured database, an association between the entity and the relationship entity for the relationship.

17. At least one non-transitory computer-readable medium comprising instructions that, in response to execution of the instructions by a computing system, cause the computing system to perform the following operations:
determining an entity lacks sufficient association in a structured database for a relationship;
generating at least one interrogative query based on the entity and the relationship;
identifying textual snippets of search result resources that are responsive to the interrogative query;
determining, based on the textual snippets, one or more candidate answers for the interrogative query;
selecting at least one answer of the candidate answers; and
defining an association for the relationship in the structured database, the association being between the entity and a relationship entity associated with the answer.
